(19) United States
(12) Patent Application Publication
(10) Pub. No.: US 2024/0021932 A1
(43) Pub. Date: Jan. 18, 2024

(54) BATTERY AND MANUFACTURING METHOD OF BATTERY

(71) Applicant: TOYOTA JIDOSHA KABUSHIKI KAISHA, Toyota-shi Aichi-ken (JP)

(72) Inventor: Yuka Nagata, Toyota-shi Aichi-ken (JP)

(73) Assignee: TOYOTA JIDOSHA KABUSHIKI KAISHA, Toyota-shi Aichi-ken (JP)

(21) Appl. No.: 18/206,238

(22) Filed: Jun. 6, 2023

(30) Foreign Application Priority Data
Jul. 15, 2022 (JP) 2022-113887

(51) Int. Cl. H01M 50/184; H01M 50/186; H01M 50/557; H01M 10/058

(52) U.S. Cl. CPC H01M 50/184; H01M 50/186; H01M 50/557; H01M 10/058; H01M 10/0525

(57) ABSTRACT

A battery includes an electrode body, a current collector terminal disposed on a side surface portion of the electrode body, and a laminate film covering the electrode body. The electrode body includes a current collector tab connected to the current collector terminal. When the battery is viewed from the current collector terminal side, the outer edge of the current collector terminal is located inside the outer edge of the electrode body. The laminate film is disposed to cover surfaces constituting the outer edge of the current collector terminal and the outer edge of the electrode body. A predetermined fused portion in which inner surfaces of the laminate film, which has a predetermined inclined surface continuously formed from the first surface at a position adjacent to an electrode body side end portion of the fused portion, are fused together is disposed at a corner portion of the current collector terminal.

### CROSS-REFERENCE TO RELATED APPLICATION

This application claims priority to Japanese Patent Application No. 2022-113887 filed on Jul. 15, 2022, incorporated herein by reference in its entirety.

### BACKGROUND

### 1. Technical Field

The present disclosure relates to a battery and a manufacturing method of the battery.

### 2. Description of Related Art

A battery such as a lithium ion secondary battery generally includes an electrode body having a positive electrode current collector, a positive electrode active material layer, an electrolyte layer, a negative electrode active material layer, and a negative electrode current collector. For example, the electrode body is sealed in an internal space surrounded by an exterior material. Japanese Unexamined Patent Application Publication No. 2011-108623 (JP 2011-108623 A) discloses a lithium polymer secondary battery including an electrode assembly, an exterior material surrounding the outside of the electrode assembly, and first and second covers sealing the exterior material, in which a first electrode terminal and a second electrode terminal are drawn outside via a first cover and a second cover, respectively. JP 2011-108623 A describes a laminate film as an exterior material. Japanese Unexamined Patent Application Publication No. 2021-190281 (JP 2021-190281 A) discloses a battery using an exterior body made of a single film, in which a rib structure in which a plurality of the above-mentioned films is stacked is provided at a corner portion of a side orthogonal to an end face on which a current collector tab lead is extended.

### SUMMARY

As shown in the FIG. 3A, FIG. 3B, FIG. 3C, and FIG. 3D, which will be described later, dimensions of the current collector terminal may be smaller than dimensions of the electrode body. When a current collector terminal having such a dimensional relationship is sealed with a laminate film, for example, wrinkles may occur in the laminate film, and a sealing property of the battery may be deteriorated. In order to solve such a problem, inventors and the like have conceived that a fused portion in which inner surfaces of the laminate films are fused to each other is provided on the current collector terminal. By providing the fused portion, it is possible to suppress a decrease in the sealing property.

On the other hand, the electrode body usually has a current collector tab for connecting to a current collector terminal. Since the current collector tab has low rigidity, when a load is applied to the current collector terminal, the laminate film (in particular, the laminate film located in the vicinity of the current collector tab) is likely to be deformed.

The present disclosure has been made in view of the above circumstances. An object of the present disclosure is to provide a battery capable of suppressing deformation of a laminate film even when a load is applied to a current collector terminal.

### First Aspect

A battery includes: an electrode body;
a current collector terminal disposed on a side surface portion of the electrode body; and
a laminate film that covers the electrode body, in which:
the electrode body includes a current collector tab connected to the current collector terminal;
in a side view of the battery from the current collector terminal side, an outer edge of the current collector terminal is located on an inner side of an outer edge of the electrode body;
the laminate film is disposed so as to cover a surface constituting the outer edge of the current collector terminal and a surface constituting the outer edge of the electrode body;
a fused portion in which inner surfaces of the laminate film are fused to each other is disposed at a corner portion of the current collector terminal;
the fused portion has a first surface, a second surface that faces the first surface and that is located on an outer side of the first surface, and a curved surface that connects the first surface and the second surface;
a normal direction of the first surface and a normal direction of the second surface are each parallel to a thickness direction of the battery;
the fused portion extends from an end portion location of the laminate film on the current collector terminal side toward the electrode body side;
the laminate film has an inclined surface provided continuously from the first surface at a location adjacent to an end portion of the fused portion on the electrode body side; and
a normal direction of the inclined surface intersects with the thickness direction of the battery.

### Second Aspect

The battery according to the first or second aspect, in which the inclined surface has a triangular shape in plan view.

### Third Aspect

The battery according to the first or second aspect, in which in a side view of the battery from the current collector terminal side, the current collector terminal has a rectangular shape.

### Fourth Aspect

The battery according to the third aspect, in which the fused portion is disposed at each of four corner portions of the current collector terminal.

### Fifth Aspect

The battery according to any one of the first to fourth aspects, in which in a side view of the battery from the current collector terminal side, a ratio (L₂/L₁) of a length L₂ of the outer edge of the current collector terminal to a length L₁ of the outer edge of the electrode body is 0.7 or more and less than 1.

### Sixth Aspect

The manufacturing method according to any one of the first to fifth aspects, including:
a preparation step of preparing a structure including the electrode body and the current collector terminal;
a first covering step of covering a surface constituting the outer edge of the electrode body in the structure with the laminate film; and
a second covering step of covering a surface constituting the outer edge of the current collector terminal in the structure with the laminate film, in which:
in the second covering step, a jig that is able to be brought into surface contact with a surface constituting the outer edge of the current collector terminal is used, and the fused portion is formed; and
as the laminate film, a laminate film including a bent portion for forming the inclined surface is used.

A battery of the present disclosure has an effect of being capable of suppressing deformation of a laminate film even when a load is applied to a current collector terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view illustrating a electrode body and a current collector terminal according to an embodiment of the present disclosure;

FIG. 1B is a schematic perspective view illustrating an electrode body and a current collector terminal according to an embodiment of the present disclosure;

FIG. 2A is a schematic perspective view illustrating an electrode body, a current collector terminal and a laminated film.

FIG. 2B is a schematic perspective view illustrating an electrode body, a current collector terminal and a laminated film.

FIG. 3A is a schematic side view and a schematic cross-sectional view illustrating an electrode body, a current collector terminal, a laminate film according to an embodiment of the present disclosure.

FIG. 3B is a schematic side view and a schematic cross-sectional view illustrating an electrode body, a current collector terminal, a laminate film according to an embodiment of the present disclosure.

FIG. 3C is a schematic side view and a schematic cross-sectional view illustrating an electrode body, a current collector terminal, a laminate film according to an embodiment of the present disclosure.

FIG. 3D is a schematic side view and a schematic cross-sectional view illustrating an electrode body, a current collector terminal, a laminate film according to an embodiment of the present disclosure.

FIG. 4A is a schematic side view illustrating a of a battery according to the present disclosure;

FIG. 4B is a schematic side view illustrating a of a battery according to the present disclosure;

FIG. 5 is a schematic side view illustrating a portion of a battery in the present disclosure;

FIG. 6 is a schematic plan view illustrating a portion of a battery in the present disclosure;

FIG. 7 is a schematic perspective view illustrating a portion of a battery in the present disclosure;

FIG. 8 is a schematic perspective view illustrating a portion of a battery in the present disclosure;

FIG. 9A is an explanatory view illustrating a normal direction of an inclined surface in the present disclosure;

FIG. 9B is an explanatory view illustrating a normal direction of an inclined surface in the present disclosure;

FIG. 10A is a schematic side view illustrating a second covering step according to the present disclosure;

FIG. 10B is a schematic side view illustrating a second covering step according to the present disclosure. and

FIG. 10C is a schematic side view illustrating a second covering step according to the present disclosure.

### DETAILED DESCRIPTION OF EMBODIMENTS

Hereinafter, embodiments of the present disclosure will be described in detail with reference to the drawings. The figures shown below are shown schematically. In the drawings shown below, the size and shape of each part are appropriately exaggerated for ease of understanding. In addition, in the present specification, when a mode in which another member is arranged with respect to a certain member is expressed, unless otherwise specified, the expression “on” or “below” includes both a case in which another member is arranged directly above or directly below a certain member so as to be in contact with the certain member, and a case in which another member is arranged above or below a certain member via another member, unless otherwise specified.

### A. Battery

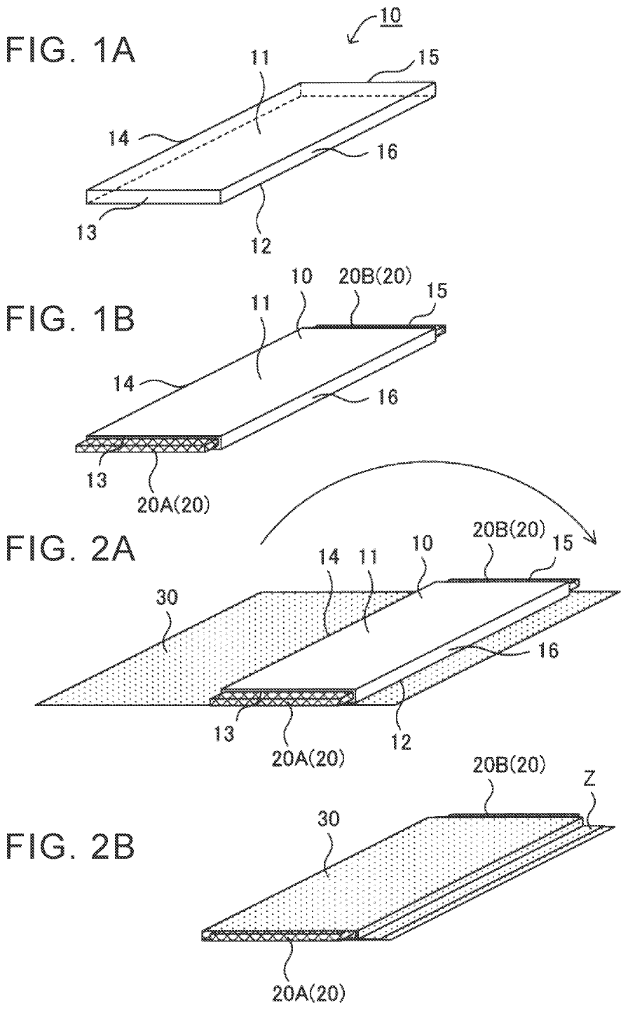

FIGS. 1A and 1B are schematic perspective views illustrating an electrode body and a current collector terminal in the present disclosure. The electrode body 10 shown in FIG. 1A includes a top surface portion 11, a bottom surface portion 12 opposed to the top surface portion 11, and four side surface portions (a first side surface portion 13, a second side surface portion 14, a third side surface portion 15, and a fourth side surface portion 16) connecting the top surface portion 11 and the bottom surface portion 12. Further, in FIG. 1B of the drawing, the first current collector terminal 20A is disposed on the first side surface portion 13 of the electrode body 10, and the second current collector terminal 20B is disposed on the third side surface portion 15 of the electrode body 10. For example, the first current collector terminal 20A is a positive electrode current collector terminal, and the second current collector terminal 20B is a negative electrode current collector terminal.

2A and 2B are schematic perspective views illustrating an electrode body, a current collector terminal, and a laminated film. As shown in 2A, the laminated film 30 is, for example, a single film. As shown in 2A and 2B, the laminated film 30 is folded so as to cover the entire bottom surface portion 12, the second side surface portion 14, the top surface portion 11, and the fourth side surface portion 16 of the electrode body 10. On the other hand, in FIG. 2B of the drawing, at least a part of the first current collector terminal 20A and at least a part of the second current collector terminal 20B are located inside the folded laminate film 30.

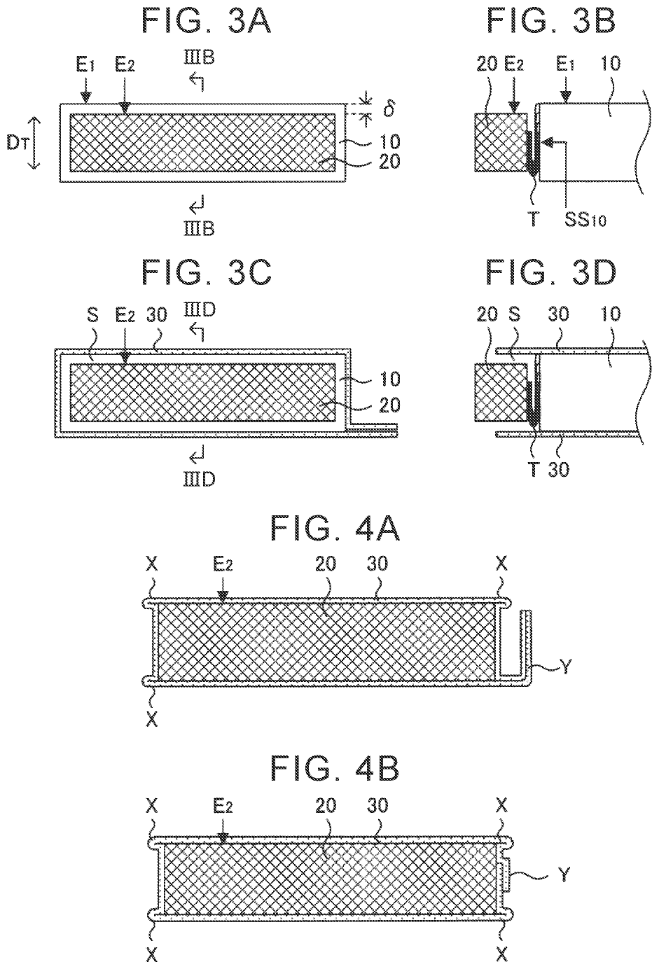

FIG. 3A is a schematic side view illustrating an electrode body of a current collector terminal; FIG. 3B is a IIIB-IIIB cross-sectional view of the FIG. 3A. As shown in 3A and 3B, when the electrode body 10 and the current collector terminal 20 are observed from the current collector terminal 20, the outer edge E₂ of the current collector terminal 20 is located inside the outer edge E₁ of the electrode body 10. That is, the size of the current collector terminal 20 is smaller than the size of the electrode body 10. Further, as shown in 3B, the electrode body 10 has the current collector tab T at the side surface portion SS₁₀. The current collector tabs T are joined at opposite surfaces of the current collector terminals 20 (surfaces facing the side surface portion SS₁₀ of the electrode body 10).

FIG. 3C is a schematic side view illustrating an electrode body, a current collector terminal and a laminated film according to an embodiment of the present disclosure. FIG. 3D is a IIID-IIID cross-sectional view of the FIG. 3C. As shown in 3C and 3D, when the electrode body 10, the current collector terminal 20, and the laminate film 30 are observed from the current collector terminal 20, a space S is formed between the laminate film 30 and the current collector terminal 20. Therefore, when the current collector terminal 20 is sealed with the laminate film 30, wrinkles may occur in the laminate film 30 due to an excessive portion of the laminate film 30, and the sealing property of the battery may deteriorate. On the other hand, as shown in the FIGS. 4B, 4A and the drawings, in the batteries of the present disclosure, the fused portions X in which the inner surfaces of the laminated films 30 (the surfaces on the current collector terminals 20 sides) are fused to each other are disposed at the corners of the current collector terminals 20. By providing the fused portion X, it is possible to suppress a decrease in sealing performance due to wrinkles of the laminate film.

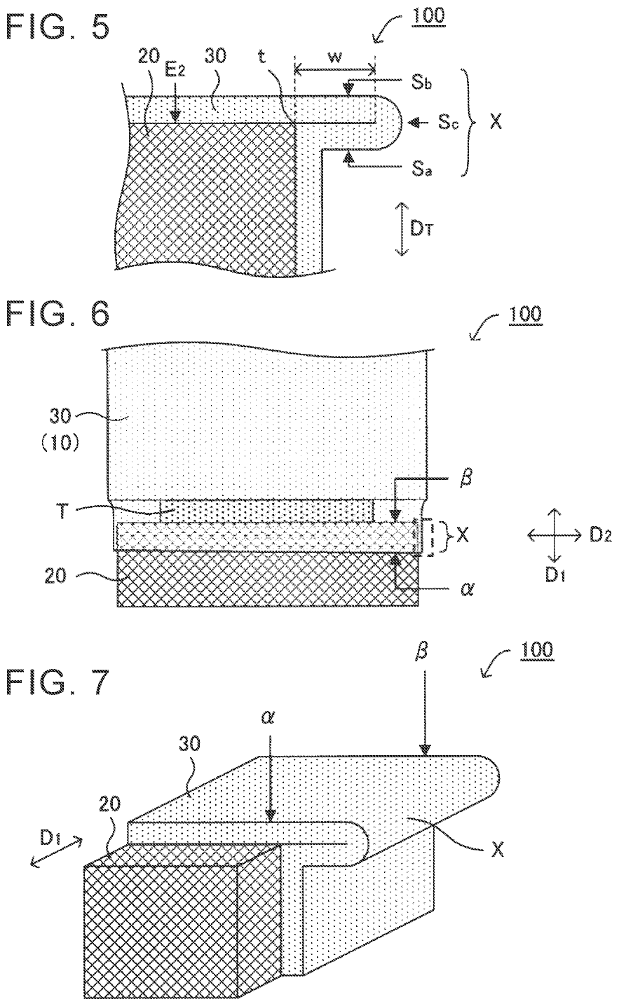

As shown in FIG. 5, the fused portion X has a first surface Sₐ, a second surface S_{b}, and a curved surface S_{c} connecting the first surface Sₐ and the second surface S_{b}. The second surface S_{b} faces the first surface Sₐ and is located further outward than the first surface Sₐ in the thickness direction D_{T} of the battery. The normal direction of the first surface Sₐ and the normal direction of the second surface S_{b} are parallel to the thickness direction D_{T} of the battery.

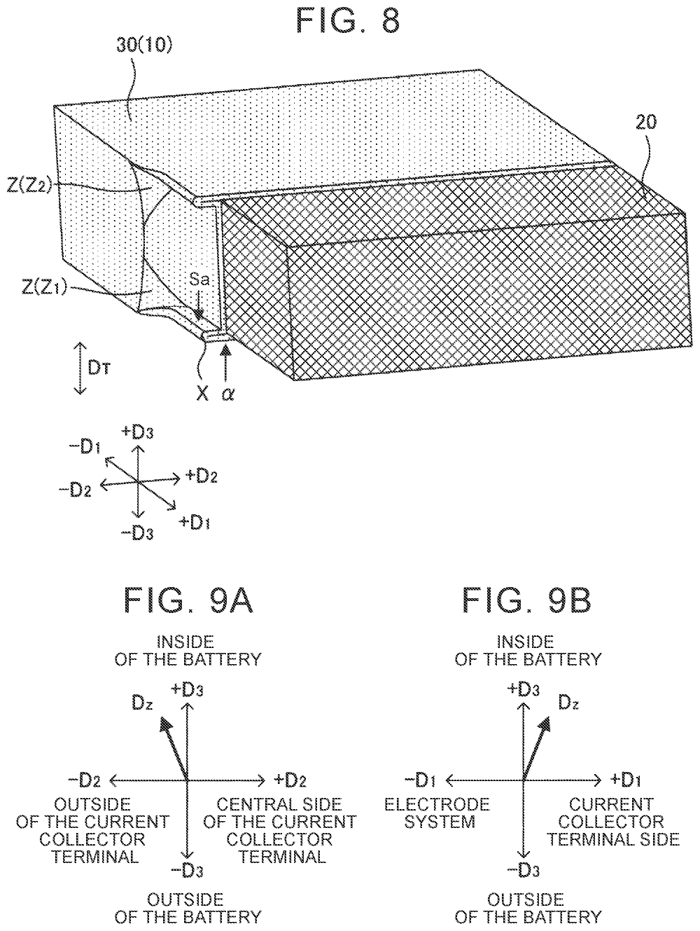

As shown in FIGS. 6 and 7, when the battery 100 is viewed in plan from the thickness direction, the end position of the laminate film 30 on the current collector terminal 20 side is α. The fused portion X extends from the end position α toward the electrode body 10. Further, as shown in FIG. 8, the laminated film 30 has an inclined surface Z continuously formed from the first surface Sₐ at a position adjoining the end portion (the end portion opposite to the end position α) of the fused portion X on the electrode body 10 side. The normal direction of the inclined surface Z intersects the thickness direction D_{T} of the battery.

According to the present disclosure, since the fused portion is disposed on the current collector terminal, a battery in which a decrease in sealing performance is suppressed is provided. As shown in the above-described FIG. 3A, the FIG. 3B, the FIG. 3C, and the FIG. 3D, the dimensions of the current collector terminals may be made smaller than the dimensions of the electrode bodies. By adopting such a dimensional relationship, it is possible to suppress the adjacent current collector terminals from coming into contact with each other, for example, when a plurality of batteries is stacked. By suppressing the adjacent current collector terminals from contacting each other, the battery is less likely to be damaged. Further, when the current collector terminal having such a dimensional relationship is sealed with a laminate film, for example, wrinkles may occur in the laminate film, and the sealing property of the battery may deteriorate. According to the present disclosure, there is provided a battery in which the fused portion X in which the inner surfaces of the laminate films are fused to each other is disposed on the current collector terminal, and thus, even when the size of the current collector terminal is made smaller than the size of the electrode body, a decrease in sealing performance is suppressed. On the other hand, as described above, the electrode body usually has a current collector tab for connecting to a current collector terminal. Since the current collector tab has low rigidity, when a load is applied to the current collector terminal, the laminate film located in the vicinity of the current collector tab is likely to be deformed. On the other hand, according to the present disclosure, there is provided a battery in which a predetermined inclined surface is provided in a laminate film, so that deformation of the laminate film located in the vicinity of the current collector tab is suppressed even when a load is applied to the current collector terminal.

### 1. Battery Configuration

The battery according to the present disclosure includes at least an electrode body, a current collector terminal, and a laminate film.

### (1) Electrode Body

The electrode body according to the present disclosure functions as a power generation element of a battery. The shape of the electrode body is not particularly limited. The electrode body includes, for example, a top surface portion 11, a bottom surface portion 12 opposed to the top surface portion 11, and four side surface portions (a first side surface portion 13, a second side surface portion 14, a third side surface portion 15, and a fourth side surface portion 16) connecting the top surface portion 11 and the bottom surface portion 12, as shown in FIG. 1A of the drawings. Both the top surface portion 11 and the bottom surface portion 12 correspond to the main surface of the electrode body, and the normal direction of the main surface can be defined as the thickness direction. The first side surface portion 13 and the third side surface portion 15 are disposed to face each other. Similarly, the second side surface portion 14 and the fourth side surface portion 16 are disposed to face each other.

The shape of the top surface portion is not particularly limited. Examples of the shape of the top surface portion include squares such as a square, a rectangle, a diamond, a trapezoid, and a parallelogram. In FIG. 1A of the drawing, the top surface portion 11 has a rectangular shape. Further, the shape of the top surface portion may be a polygon other than a quadrangle. The shape of the top surface portion may be a shape having a curve such as a circle. Also, the shape of the bottom surface portion is the same as the shape of the top surface portion. The shape of the side portion is not particularly limited. Examples of the shape of the side surface portion include squares such as a square, a rectangle, a diamond, a trapezoid, and a parallelogram.

### (2) Current Collector Terminal

The current collector terminal in the present disclosure is disposed on a side surface portion of the electrode body. In some embodiments, the battery according to the present disclosure includes two current collector terminals for one electrode body. For example, as shown in 1B, the pair of current collector terminals 20 (the first current collector terminal 20A and the second current collector terminal 20B) may be disposed to face the electrode body 10. Further, in FIG. 1B shown in the drawing, the pair of current collector terminals 20 are arranged to face each other in the longitudinal direction of the electrode body 10.

When the battery is viewed from the side of the current collector terminal, the shape of the current collector terminal is not particularly limited. Examples of the shape of the current collector terminal include squares such as a square, a rectangle, a diamond, a trapezoid, and a parallelogram. In the illustrated 3A, the current collector terminal 20 has a rectangular shape. In this rectangle, the short side extends along a direction parallel to the thickness direction D_{T}, and the long side extends along a direction perpendicular to the thickness direction D_{T}.

When the battery is viewed from the side of the current collector terminal, the outer edge of the current collector terminal is located inside the outer edge of the electrode body. For example, as shown in 3A, the outer edge E₂ of the current collector terminal 20 is located inside the outer edge E₁ of the electrode body 10. In other words, the outer edge E₂ of the current collector terminal 20 is included in the outer edge E₁ of the electrode body 10 over the entire circumference.

For example, in FIG. 3A shown in the drawing, the length (total circumferential length) of the outer edge E₁ in the electrode body 10 is L₁, and the length (total circumferential length) of the outer edge E₂ of the current collector terminal 20 is L₂. The ratio of L₂ to L₁ (L₂/L₁) may be, for example, greater than or equal to 0.7 and less than 1. The ratio of L₂ to L₁ (L₂/L₁) may be, for example, 0.8 or more and 0.95 or less. Further, for example, in FIG. 3A shown in the drawing, the length of the outer edge E₁ in the thickness direction D_{T} is Lₐ, and the length of the outer edge E₂ in the thickness direction D_{T} is L_{b}. The ratio of L_{b} to Lₐ (L_{b}/Lₐ) may be, for example, greater than or equal to 0.5 and less than 1. The ratio of L_{b} to Lₐ (L_{b}/Lₐ) may be, for example, 0.8 or more and 0.95 or less. Further, for example, in FIG. 3A shown in the drawing, the length of the outer edge E₁ in the direction orthogonal to the thickness direction D_{T} is L_{c}, and the length of the outer edge E₂ in the direction orthogonal to the thickness direction D_{T} is L_{d}. The ratio of L_{d} to L_{c} (L_{d}/L_{c}) may be, for example, greater than or equal to 0.5 and less than 1. The ratio of L_{d} to L_{c} (L_{d}/L_{c}) may be, for example, 0.8 or more and 0.95 or less. Further, for example, in FIG. 3A of the drawing, the length of the gap between the outer edge E₁ and the outer edge E₂ is set to δ. δ may be greater than 0 mm and greater than or equal to 0.3 mm. δ may be greater than or equal to 0.5 mm. On the other hand, δ is, for example, 1.5 mm or less.

### (3) Laminate Film

The laminate film in the present disclosure covers the electrode body and seals the electrode body together with the current collector terminal. As shown in 2A and 2B, when the electrode body 10 and the current collector terminal 20 are observed from the current collector terminal 20, the laminate film 30 is disposed so as to cover the surface constituting the outer edge of the current collector terminal 20 and the surface constituting the outer edge of the electrode body 10. Further, as shown in the FIG. 4A, a fused portion X in which the inner surfaces of the laminated films 30 are fused to each other is disposed at a corner portion of the current collector terminal 20. In some embodiments, the fused surface in the fused portion X has no voids. The laminate film may have one fused portion X. The laminate film may have two or more fused portions X. In addition, the fused portions X may be disposed at two corner portions of the current collector terminals that face each other in the thickness direction. Further, in FIG. 4A shown in the drawing, the end close contact portion Y in which the end portions of the laminated films 30 are fused to each other is arranged. Since the excess space can be reduced, the end close contact portion Y may be bent in accordance with the shape of the current collector terminal. Further, as shown in FIG. 4B, the current collector terminal 20 may have a rectangular shape, and the fused portions X may be disposed at all corners thereof. In FIG. 4B shown in the drawing, the end close contact portion Y is disposed on a side connecting the two corners.

As shown in FIG. 5, the fused portion X has a first surface Sₐ, a second surface S_{b}, and a curved surface S_{c} connecting the first surface Sₐ and the second surface S_{b}. The second surface S_{b} faces the first surface Sₐ and is located further outward than the first surface Sₐ in the thickness direction D_{T} of the battery. The normal direction of the first surface Sₐ and the normal direction of the second surface S_{b} are parallel to the thickness direction D_{T} of the battery. “Parallel” means that the angle formed by the two is 20° or less.

In FIG. 5, when the battery 100 is viewed from the side of the current collector terminal 20, the fused portion X is disposed at a corner portion constituting the outer edge E₂ of the current collector terminal 20. Specifically, the corner portion constituting the outer edge E₂ of the current collector terminal 20 coincides with the end portion t of the fusion surface in the fused portion X. Further, as shown in FIG. 5, the width of the fused surface in the fused portion X is w. The width w may be, for example, greater than or equal to 0.1 mm. The width w may be, for example, 0.3 mm or more. The width w may be, for example, 0.6 mm or more. On the other hand, the width w is, for example, 1.2 mm or less.

As shown in FIGS. 6 and 7, when the battery 100 is viewed in a plan view from the thickness direction, the end position of the laminate film 30 on the side of the current collector terminal 20 is represented by a, and the position of the laminate film 30 corresponding to the boundary between the current collector terminal 20 and the electrode body 10 is represented by β. The fused portions X in FIGS. 6 and 7 are arranged continuously from the end position a to the position β. In some embodiments, when the direction (axial direction) in which the current collector terminal 20 extends from the electrode body 10 is D₁, the fused portion X is arranged along D₁. Further, the fused portion X may be disposed in at least a part of the area from the end position α to the position β in D₁. The length of the fused portion X in D₁ may be, for example, 1 mm or more. The length of the fused portion X in D₁ may be, for example, 3 mm or more. The length of the fused portion X in D₁ may be, for example, 5 mm or more.

As shown in FIG. 8, the laminated film 30 has an inclined surface Z continuously formed from the first surface Sₐ at a position adjoining the end portion (the end portion opposite to the end portion position α) of the fused portion X on the electrode body side. The normal direction of the inclined surface Z intersects the thickness direction D_{T} of the battery. “Crossing” means that the angle formed by both is greater than 20°. The inclined surface Z may be a flat surface. The inclined surface Z may be a curved surface. The normal direction of the inclined surface Z refers to a normal direction at the center of gravity of the inclined surface Z. Further, as shown in FIG. 8, the direction (axial direction) in which the current collector terminal 20 extends from the electrode body 10 is D₁, the direction corresponding to the thickness direction D_{T} of the battery is D₃, and the direction perpendicular to D₁ and D₃ is D₂. 9A and 9B are explanatory diagrams for describing the normal direction of the inclined surface Z₁ in FIG. 8. As shown in 9A, in some embodiments, when the inclined surface Z is seen from D₁, the normal direction D_{Z} points to the outer side of the current collector terminal (—D₂). Further, as shown in the FIG. 9B, when the inclined surface Z is seen from D₂, the normal direction D_{Z} preferably points to the current collector terminal side (+D₁ side). In some embodiments, as shown in 9A and 9B, the height component (D₃ component) of the normal direction D_{Z} indicates the inside of the battery. Note that, although not specifically shown, when the inclined surface Z₂ in FIG. 8, −D₃ side corresponds to the inside of the battery, and the +D₃ side corresponds to the outside of the battery. In some embodiments, the inclined surface has a triangular shape in plan view. The triangular shape includes not only a strict triangle but also one in which at least one of the sides constituting the triangular shape is curved.

### 2. Components of the Battery

A battery according to the present disclosure includes an electrode body, a current collector terminal, and a laminate film.

### (1) Electrode Body

The electrode body in the present disclosure generally includes a positive electrode current collector, a positive electrode active material layer, an electrolyte layer, a negative electrode active material layer, and a negative electrode current collector in this order in the thickness direction.

The positive electrode active material layer contains at least a positive electrode active material. The positive electrode active material layer may further contain at least one of a conductive material, an electrolyte and a binder. Examples of the positive electrode active material include an oxide active material. Examples of the oxide active material include a rock salt layered active material such as LiNi_{1/3}Co_{1/3}Mn_{1/3}O₂, a spinel-type active material such as LiMn₂O₄, and an olivine-type active material such as LiFePO₄. Further, sulfur (S) may be used as the positive electrode active material. The shape of the positive electrode active material is, for example, particulate.

Examples of the conductive material include carbon material. The electrolyte may be a solid electrolyte. The electrolyte may also be a liquid electrolyte. The solid electrolyte may be an organic solid electrolyte such as a gel electrolyte. The solid electrolyte may be an inorganic solid electrolyte such as an oxide solid electrolyte or a sulfide solid electrolyte. The liquid electrolyte contains, for example, a support salt such as LiPF₆ and a solvent such as a carbonate-based solvent. Examples of the binder include a rubber-based binder and a fluoride-based binder.

The negative electrode active material layer contains at least a negative electrode active material. The negative electrode active material layer may further contain at least one of a conductive material, an electrolyte and a binder. Examples of the negative electrode active material include metal active material such as Li and Si, carbon active material such as graphite, and oxide active material such as Li₄Ti₅O₁₂. The shape of the negative electrode active material is, for example, a particulate shape or a foil shape. The conductive material, the electrolyte and the binder are similar to those described above.

The electrolyte layer is disposed between the positive electrode active material layer and the negative electrode active material layer. The electrolyte layer contains at least an electrolyte. The electrolyte may be a solid electrolyte. The electrolyte may also be a liquid electrolyte. The electrolyte is similar to those described above. The electrolyte layer may have a separator.

The positive electrode current collector collects current from the positive electrode active material layer. Examples of the material of the positive electrode current collector include metals such as aluminum, SUS, and nickel. Examples of the shape of the positive electrode current collector include a foil shape and a mesh shape. The positive electrode current collector may have a positive electrode tab for connection with the positive electrode current collector terminal.

The negative electrode current collector collects current from the negative electrode active material layer. Examples of the material of the negative electrode current collector include metals such as copper, SUS, and nickel. Examples of the shape of the anode current collector include a foil shape and a mesh shape. The negative electrode current collector may have a negative electrode tab for connection with the negative electrode current collector terminal.

### (2) Current Collector Terminal

The current collector terminal in the present disclosure is disposed on a side surface portion of the electrode body. The current collector terminal refers to a terminal having a current collector at least in part. The current collector is electrically connected to, for example, a tab in the electrode body. The current collector terminal may be entirely a current collector. A part of the current collector terminal may be a current collector. The current collector terminal is made of, for example, aluminum, SUS, or the like.

### (3) Laminate Film

The laminate film in the present disclosure has at least a structure in which a heat-fusion layer and a metal layer are laminated. Moreover, the laminate film may have the heat-fusion layer, the metal layer and a resin layer in this order along the thickness direction. Examples of the material of the heat-fusion layer include an olefin-based resin such as polypropylene (PP) and polyethylene (PE). Examples of the material of the metal layer include aluminum, aluminum alloy, and stainless steel. Examples of the material of the resin layer include polyethylene terephthalate (PET) and nylon. The thickness of the heat-fusion layer is, for example, 40 μm or more and 100 μm or less. The thickness of the metal layer is, for example, 30 μm or more and 60 μm or less. The thickness of the resin layer is, for example, 20 μm or more and 60 μm or less. The thickness of the laminate film is, for example, 80 μm or more and 250 μm or less.

### (4) Battery

The battery in the present disclosure is typically a lithium ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In some embodiments, the batteries according to the present disclosure are used in a power supply for driving hybrid electric vehicle (HEV), plug-in hybrid electric vehicle (PHEV) or battery electric vehicle (BEV). In addition, the battery in the present disclosure may be used as a power source for a moving object (for example, a railway, a ship, or an aircraft) other than a vehicle. The battery in the present disclosure may be used as a power source for an electric product such as an information processing apparatus. Further, in the present disclosure, it is also possible to provide a battery module in which a plurality of the above-described batteries are stacked in the thickness direction.

### Process for Producing B. Battery

A method of manufacturing a battery according to the present disclosure includes: a preparation step of preparing a structure having the electrode body and the current collector terminal; a first covering step of covering a surface of the structure forming the outer edge of the electrode body with the laminate film; and a second covering step of covering a surface of the structure forming the outer edge of the current collector terminal with the laminate film. In the second covering step, a jig capable of surface contact with a surface constituting the outer edge of the current collector terminal is used, and the fused portion is formed. As the laminate film, a laminate film having a bent portion for forming the inclined surface is used.

According to the present disclosure, it is possible to obtain a battery in which a decrease in sealing performance is suppressed by forming a fused portion. Further, the use of the laminate film having the bent portion facilitates the formation of the inclined surface.

### 1. Preparation Step

The preparation step in the present disclosure is a step of preparing a structure including the electrode body and the current collector terminal. The electrode body and the current collector terminal are the same as those described in the above-described “A. battery”, and therefore will not be described here.

### 2. First Covering Step

The first covering step in the present disclosure is a step of covering the outer edge of the electrode body in the structure with the laminate film. For example, as shown in 2A and 2B, in the first covering step, the surface (for example, the bottom surface portion 12, the second side surface portion 14, the top surface portion 11, and the fourth side surface portion 16) constituting the outer edge of the electrode body 10 is covered with the laminated film 30. At this time, the electrode body 10 and the laminate film 30 may be welded. The electrode body 10 and the laminate film 30 may not be welded. Further, as shown in 2B, the end overlapping portions Z where the end portions of the laminated films 30 overlap each other are heated. As a result, the end close contact portion Y in which the end portions of the laminate film 30 are fused to each other is formed. The laminate film may be bent in advance in accordance with the shape of the electrode body.

In addition, in the first covering step, normally, as shown in the FIG. 3C and the FIG. 3D, a space S is formed between the laminated film 30 and the current collector terminal 20. This space S disappears in a second covering step described later, and a fused portion is formed instead.

### 3. Second Covering Step

The second covering step in the present disclosure is a step of covering a surface constituting the outer edge of the current collector terminal with the laminate film. Further, in the second covering step, the fused portion is formed. As the laminate film, a laminate film having a bent portion for forming an inclined surface is used.

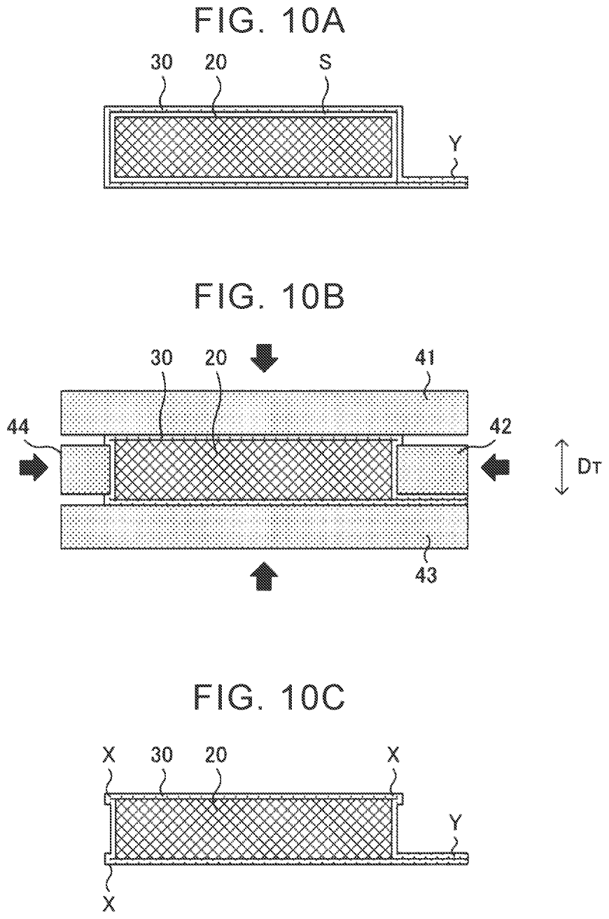

In the second covering step, the current collector terminal and the laminate film are welded together using a jig capable of making surface contact with the surface forming the outer edge of the current collector terminal. A schematic side view illustrating a second covering step in the present 10A, FIG. 10B, and FIG. 10C. As shown in 10A, a space S is formed between the laminated film 30 and the current collector terminal 20 by the above-described first covering step. In addition, the end close contact portion Y is formed by the above-described first covering step. Next, as shown in the FIG. 10B, the jig 41, the jig 42 and the jig 43 and the jig 44 are pushed against the laminated film 30 and the current collector terminal 20. In some embodiments, the jigs 41 to 44 are heated. In the thickness direction D_{T}, the length of the jig 42 and the jig 44 (the length in the vertical direction of the drawing) is shorter than the length of the current collector terminal 20 (the length in the vertical direction of the drawing). Therefore, a gap is formed between the jig 41 and the jig 42, and excess portions of the laminate film 30 collect in the gap. As a result, as shown in the FIG. 10C, the fused portion X is formed. Further, in the present disclosure, as the laminate film a film having a bent portion for forming an inclined surface is used, whereby the inclined surface is stably formed.

### 4. Battery

The battery obtained by the above-described step is the same as the content described in the above-described “A. battery”, and therefore the description thereof will be omitted.

The present disclosure is not limited to the above embodiments. The above embodiment is an example. Any device having substantially the same configuration as the technical idea described in the claims in the present disclosure and having the same operation and effect is included in the technical scope of the present disclosure.

What is claimed is:

1. A battery comprising:
an electrode body;
a current collector terminal disposed on a side surface portion of the electrode body; and
a laminate film that covers the electrode body, wherein:
the electrode body includes a current collector tab connected to the current collector terminal;
in a side view of the battery from the current collector terminal side, an outer edge of the current collector terminal is located on an inner side of an outer edge of the electrode body;
the laminate film is disposed so as to cover a surface constituting the outer edge of the current collector terminal and a surface constituting the outer edge of the electrode body;
a fused portion in which inner surfaces of the laminate film are fused to each other is disposed at a corner portion of the current collector terminal;
the fused portion has a first surface, a second surface that faces the first surface and that is located on an outer side of the first surface, and a curved surface that connects the first surface and the second surface;
a normal direction of the first surface and a normal direction of the second surface are each parallel to a thickness direction of the battery;
the fused portion extends from an end portion location of the laminate film on the current collector terminal side toward the electrode body side;
the laminate film has an inclined surface provided continuously from the first surface at a location adjacent to an end portion of the fused portion on the electrode body side; and
a normal direction of the inclined surface intersects with the thickness direction of the battery.

2. The battery according to claim 1, wherein the inclined surface has a triangular shape in plan view.

3. The battery according to claim 1, wherein in a side view of the battery from the current collector terminal side, the current collector terminal has a rectangular shape.

4. The battery according to claim 3, wherein the fused portion is disposed at each of four corner portions of the current collector terminal.

5. The battery according to claim 1, wherein in a side view of the battery from the current collector terminal side, a ratio (L₂/L₁) of a length L₂ of the outer edge of the current collector terminal to a length L₁ of the outer edge of the electrode body is 0.7 or more and less than 1.

6. A manufacturing method of the battery according to claim 1, the manufacturing method comprising:
a preparation step of preparing a structure including the electrode body and the current collector terminal;
a first covering step of covering a surface constituting the outer edge of the electrode body in the structure with the laminate film; and
a second covering step of covering a surface constituting the outer edge of the current collector terminal in the structure with the laminate film, wherein:
in the second covering step, a jig that is able to be brought into surface contact with a surface constituting the outer edge of the current collector terminal is used, and the fused portion is formed; and
as the laminate film, a laminate film including a bent portion for forming the inclined surface is used.
